(19) United States
(12) Patent Application Publication
(10) Pub. No.: US 2025/0296297 A1
(43) Pub. Date: Sep. 25, 2025

(54) LAMINATE WITH EDGE SEAL AND ELECTRICAL CONNECTOR SYSTEM

(71) Applicant: AGP WORLDWIDE OPERATIONS GMBH, Zug (CH)

(72) Inventors: Natalia A. RUEDA, Lima (PE); Juan Felipe CASTRO, Lima (PE); Andrés Fernando SARMIENTO, Canton, MI (US); Mauricio SALAZAR ASTETE, Lima (PE); Daniel ESTRADA DIAGO, Lima (PE)

(21) Appl. No.: 18/861,553

(22) PCT Filed: May 1, 2023
(86) PCT No.: PCT/IB2023/054525

§ 371 Date: Oct. 29, 2024

Related U.S. Application Data
(60) Provisional application No. 63/337,058, filed on Apr. 30, 2022.

(51) Int. Cl. B32B 17/10; B32B 7/12; B60R 16/02

(52) U.S. Cl. CPC B32B 17/10036; B32B 7/12; B32B 17/10302; B32B 17/10376; B60R 16/0215; B32B 2305/08; B32B 2305/34

(57) ABSTRACT

The disclosure refers to a laminated glazing having a connector which includes an electrical bridging means and an optional reinforcement making failure unlikely.

### FIELD OF THE INVENTION

The invention relates to the field of automotive glazing.

### BACKGROUND OF THE INVENTION

With the trend towards full autonomous vehicles, as well as consumer demand for increased levels of comfort, convenience, and safety, the complexity of modern automotive glazing has been increasing at a rapid rate. Often times, the glazing is used as a platform for and becomes an integral permanent part of new and innovative technology.

Laminated glazings lend themselves well to many of the new technologies as it is possible to embed various materials and devices within the polymer layers of the glazing. The glazing also occupies a substantial portion of the cabin interior and vehicle exterior surface area. We shall refer to these materials and devices that are embedded within the laminate as inserts. We can classify inserts as passive of active. Solar control films are an example of a passive insert which requires no power. Active inserts are those that require an electrically conductive connection from the insert to the exterior of the glazing. Films on which the level of light transmission can be varied electrically are an example of active inserts. Likewise, laminates containing LED lights, touch sensors, heated defroster circuits, antennas and other electrical devices are also active inserts.

Active inserts require an electrical connecting means between the vehicle wiring and the active insert. Due to the brittle nature of glass and for various other reasons, it is not practical to make holes in laminated glass so the electrical connection must generally pass from the active insert between the layers of the laminate and exit from the laminate at the edge of the laminate.

The electrical connection between the active insert and the vehicle, has typically been accomplished by means of a thin, flat, solid, copper, conductor soldered to the active insert electrical connection point inside of the laminate, which then extends outboard of the edge of laminate. The thin copper is very weak and easily damaged, so it is typical to transition to a round stranded copper conductor soldered to the flat conductor. The transition from the flat to round conductor is also typically protected by a shell or polymer over-mold. The round stranded wire then terminates in an electrical pin which inserted into a plastic shell which connects to a mating shell on the vehicle wiring harness.

Laminates, in general, are articles comprised of multiple layers of thin, relative to their length and width, material, with each thin layer having two oppositely disposed major faces, typically of uniform thickness, which are permanently bonded to one and other across at least one major face of each layer. The layers of a laminate may alternately be described as sheets or plies. In addition, the glass layers of a glazing may be referred to as panes.

Laminated safety glass is made by bonding two layers of annealed glass together using a solid polymer bonding layer comprised of a thin sheet of transparent thermoplastic (interlayer).

Safety glass is glass that conforms to all applicable industry and government regulatory safety requirements for the application.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the polymer layer helping to maintain the structural integrity of the glass. A vehicle with a broken windshield can still be operated. The polymer layer also helps to prevent penetration by objects striking the laminate from the exterior and in the event of a crash occupant retention is improved.

All windshields are required by law to be annealed, laminated, safety glass. All of the other glazed positions typically are made of tempered glass although laminated glass can be used in any position.

The polymer bonding layer (interlayer) has the primary function of bonding the major faces of adjacent layers to each other. The material selected is typically a clear thermoplastic polymer. The polymer interlayer used to laminate all safety glass windshields is index matched to the index of refraction of the glass to prevent internal reflections. For automotive use, the preferred bonding layer (interlayer) is polyvinyl butyral (PVB). In addition to being the most economical, PVB has excellent adhesion to glass and is optically clear once laminated. In addition to PVB, ionoplast polymers, ethylene vinyl acetate (EVA), cast in place (CIP) liquid optically clear adhesive (LOCA) and thermoplastic polyurethane (TPU) can also be used.

Automotive interlayers are made by an extrusion process. To facilitate the handling of the polymer sheet during assembly the surfaces of the interlayer are normally embossed, as a smooth surface tends to stick to the glass trapping air and making it difficult to position the interlayer on the glass. Standard thicknesses for automotive PVB interlayer at 0.38 mm and 0.76 mm (15 and 30 mil).

As the interlayer is soft and pliable, it is possible to embed some of the various articles needed to implement additional functionality within the laminate.

Thin wires for heating are commonly embedded just under the surface of the interlayer by localized application of heat or ultrasound.

As a rule of thumb, an insert such as a film, bus bar, sensor, wire, lead, or other object can be laminated if the thickness is not more than ⅓ of the total thickness of the interlayer. The interlayer is soft at room temperature. During the lamination process, the interlayer is held at an elevated temperature under high pressure and will flow to accommodate the insert if the insert is thin enough. The maximum insert thickness will depend upon other factors such as the other dimensions of the object, the thickness of the glass, the strength of the glass, the specific interlayer and the time, temperature, and pressure of the lamination cycle. If the object is too thick, the glass may break. Objectionable distortion can also occur. With all other factors remaining the same, thinner is always better with respect to the risk of breakage and distortion.

In the event of an impact in the area of the insert, the laminate must still meet requirements for penetration resistance and spalling of the glass. As a result, it may be necessary to provide an additional sheet of interlayer so that the insert is captured between the two sheets or to bond the insert to the glass surface itself. With smaller inserts, an adhesive may be used to bond the insert to the glass.

One common active insert is a variable light transmission film (VLT). Variable light transmission films, as well as other performance films must be sandwiched between two sheets of interlayer due to the large area that they cover.

To control the level of light transmission through the laminate, there are many technologies available: electrochromic, photochromic, thermochromic and electric field sensitive films which are designed to be incorporated into laminated glass. Of interest are suspended particle device (SPD) films and polymer dispensed liquid crystal (PDLC) films which can quickly change their light transmittance in response to an electrical field. Other types of switchable films include liquid crystal (LC) and electrochromic.

Due to the thickness of the VLT film in the area where the bus bars and connectors are attached, the film can be difficult to laminate even with two full thickness layers of interlayer.

With VLT films, two sheets of interlayer are required, so a thicker insert can be accommodated than would otherwise be possible. As an example, applying the ⅓ rule of thumb, with an 0.76 and an 0.38 interlayer, we can have an insert with a thickness of up to 0.38 mm. As VLT films draw very little power and as a result do not require thick or wide bus bars, that maximum thickness is typically sufficient. The only area where we may have a problem is where the connector that brings power into the laminate is attached to the bus bar, which may increase the thickness.

An exploded view of a VLT film is shown in FIG. 8. Two PET substrates 50 are coated with a transparent conductive coating 42. The active material 44 is sandwiched in between the two substrates 50 and in contact with the conductive coating 42 on both side of the active material 44. The substrate opposite each busbar is cut back and the active material is removed exposing the conductive coating. The bus bars 40 are adhered to the conductive coating 42 of each substrate by means of a conductive adhesive (not shown) to the exposed conductive coating 42. A thin insulating tape 46 with an adhesive backing is then applied over each bus bar 40.

Wire embedded heated laminates as well as laminates with VLT films, also require the addition of bus bars to distribute the electrical power needed further increasing the thickness in the bus bar areas. With embedded wire heated circuit bus bars, a substantial amount of current is drawn requiring thicker and wider bus bars. When a single layer of interlayer is used the maximum thickness of the insert is less than that of a VLT film with two layers of interlayer. When this is the case, it is often necessary to “carve” a trough in the PVB for the bus bars.

Active inserts such as LEDs, touch sensors, light fibers, sensors, and other devices due to their thickness and irregular shape can present a challenge when working with polymer interlayer sheets.

It is not so much the thickness as the rate of change that causes problems. If a film of uniform thickness extends to the edge of glass, then the only issue will be wrinkling of the film as the flat film is forced to conform to the curvature of the glass. In this case, the ⅓ rule does not apply. However, it is typical to cut back the film from the edge of glass so as to protect the edge of the film from exposure to the elements and to minimize the amount of film needed. This step change in thickness is where problems can occur. If the change is too great, a spacer may be needed. One method used to prevent breakage has been to insert a spacer running from the edge of the film to the edge of glass. In this way, the abrupt step change in thickness at the edge of the film is avoided.

If the insert is ˜⅓ the thickness of the interlayer, then the lamination may be successful. Other process parameters must also be adjusted. It is advisable to heat and soften the interlayer before vacuum is applied and to ramp up pressure as a slower rate that would otherwise be used.

Laminates with inserts share some common disadvantages.

The lamination process includes the steps of assembling the layers, removing air from the assembly, and then processing the assembly at an elevated temperature and pressure in an autoclave.

Prior to the autoclave step, it is necessary to remove as much air as possible from the assembly. There are two widely used methods used to remove the air from a laminate, the vacuum method, and the pinch roller method. In both processes, the laminate is heated so as to partially melt the interlayer causing it to adhere to the glass layers and seal the edges. The assembly is heated to a temperature that is high enough to make the interlayer tacky and remove the embossing pattern on the interlayer surface but not high enough to completely melt the interlayer.

For most ordinary laminates, which do not have extreme curvature or inserts, the pinch roller system is used. The heated assembly is passed through a set of soft flexible rollers, curved to the average shape of the laminate which are used to pinch the two layers together adhering the glass layers to the tacky interlayer and forcing the air out. The small amount of air remaining is forced out by the high pressure of the autoclave.

The vacuum method is used to evacuate the air from the laminate and adhere the glass layers to the interlayer. The entire assembly is placed inside of a bag, or a channel is applied to the periphery. The assembly is heated with the vacuum applied and atmospheric pressure forces the assembly together. This method must be used for most laminates with inserts including performance films.

As one can imagine, the labor associated with the vacuum method is much higher. In general, workers are needed to apply and remove the channel or bag whereas the pinch roller method is automated. The length of the lamination process may also need to be increased.

Even when successfully laminated, the variations in thickness caused by the inserts can cause optical distortion and areas of tension and compression across the surface.

The areas of high tension may lead to the premature failure of the glass. The probability of failure is a function of stress, duration, and time. If there is any stress locked in the glass, the duration goes to infinity and the probability of breakage goes to 100% although the time that it may take can be quite lengthy at low levels of stress. At any rate, the probability of breakage will be greater than zero.

We also find that some types of inserts are not able to survive the vacuum, pressure, and temperature of the lamination process. In these cases, the only option is to use a Liquid Optically Clear Adhesive (LOCA) or comparable product, a process also known as cold lamination.

With conventional solid polymer interlayers (thermoplastic interlayers), components must be flat and a fraction of the thickness of the interlayer. Further, the more expensive vacuum channel/bag method must be used to laminate the glazing. Even when lamination is successful, yield loss, the potential for breakage and distortion will all tend to be higher.

While optically clear thermoset LOCAs have been available for many years, they have primarily been used for non-glazing applications where the gap between the laminate layers is very large and/or irregular.

Attempts have been made to use thermoset optically clear LOCAs in place of the solid interlayer. LOCAs that are UV cured are preferred due to their short cure time.

It would be advantageous to fill the gap between the layers of the laminate with a viscous, transparent, optically clear, index of refraction matched, liquid adhesive, which would fill and conform to the gap between layers and to the contours of the various inserts that may be needed. The liquid also must have high adhesion to the glass and other inserts and the capability to be cured after the gap has been filled.

This type of product has been developed and is commonly known as a liquid optically clear adhesive or LOCA. With a LOCA, the only restriction on inserts is that they can be no thicker that the design gap between the layers. The finished laminate will have none of the residual stress caused by the thickness of the insert or surface mismatch. In fact, it has been found that the optical quality of a laminate made with a LOCA is sometimes far better than that of the same glass made with an interlayer.

There are a limited number of LOCAs that are suitable for automotive use. Any product that is used in a vehicle must meet the very severe automotive environmental test requirements. The glazing must be able to withstand extremes of temperature ranging from −40° C. to 80° C., 100% humidity, intense UV exposure, salt exposure and many other requirements. Further, the glazing must last for the life of the vehicle. The LOCA must also be environmentally friendly and not toxic.

Many of the various LOCAs that are suitable for automotive glazing use are susceptible to degradation from exposure to water. Even exposure to humidity can be a problem. Some of the materials used in active inserts can also be damaged by exposure to humidity and water. As a result, glazing that is laminated with a LOCA must also have an edge sealer applied to protect the LOCA. The edge seal also serves as a dam containing the LOCA inside of the assembly during fill prior to the LOCA being cured.

Like the LOCAs, there are a very limited number of materials that are suitable for use in an automotive glazing as an edge seal.

The available LOCAs and edge sealants function well for their intended use. They have good adhesion to glass. However, adhesion to the typical materials used to insulate electrical conductors or connectors, such as polyimide tape is not as good. As the LOCA and edge seal materials remain soft, any movement in the electrical connection during installation, service and operation can serve to break the seal. If an electrical conductor must pass through the LOCA and the edge seal, there is a probability that is significantly higher than zero that at some point the conductor may become a path for water and humidity to enter the laminate.

The ingress of water can cause the LOCA to lose its transparency and in extreme cases cause the bond to the glass to weaken allowing the glazing to de-laminate, requiring replacement. Also, the active inserts are also likely to be damaged.

It would be highly desirable to have a connection means that would not have these drawbacks.

### BRIEF SUMMARY OF THE INVENTION

The invention provides a protection means that enables a watertight electrical connection between the exterior of the laminated glazing and the active insert. The protection means comprises a bridging means, a reinforcement element or a combination thereof. The bridging means may be implemented as a conductive coating deposited on an interior pane surface, one or more conductors embedded in an interlayer or one or more conductors passing through the interlayer. The inboard end of the bridge conductor is connected to the electrical connection point of the active insert. The other end is outboard of the edge seal and connects to the wiring harness connector. In this manner the conductor bridges the edge seal breaking the path of potential water/humidity ingress without passing through it. The reinforcement element may be applied over the edge of the laminate, sealing, and preventing movement of the conductor which can lead to leaks. Both, the bridging means and the reinforcement may also be configured to work collaboratively to provide protection against external fluid while maintain mechanically protecting the connection.

### Advantages

Provides a reliable electrical connection that is not likely to fail.
Implemented with standard automotive glazing equipment.
Simplifies assembly of the laminate.

In this sense, the invention discloses a laminated glazing comprising two panes, an outer pane and an inner pane, each pane having an exterior surface oriented towards the outside of the laminated glazing, an interior surface oriented towards the inside of the laminated glazing, and an edge surface; an edge sealing means disposed in between said outer and inner panes and applied around the periphery of the glazing; a curable liquid optically clear adhesive added into the laminate in at least a portion of the void between the two panes and serving to permanently join at least a portion of the interior surfaces of said two panes; an active insert having at least one electrical connection point; a wiring connector having at least one electrical connection point; and a protection means serving to protect the wiring connector. Additionally, the invention also discloses a vehicle having such laminated glazing.

### BRIEF DESCRIPTION OF THE SEVERAL VIEWS OF THE DRAWINGS

FIG. 1A shows the cross-section of a typical laminated automotive glazing.

FIG. 1B shows the cross-section of a typical laminated automotive glazing with performance film and coating.

FIG. 2 shows the exploded isometric view of a side window having an active insert laminated with LOCA.

FIG. 3 shows the side view of the side window of FIG. 2 with an active insert laminated with LOCA.

FIG. 4 shows the cross-section AA from FIG. 3.

FIG. 5 shows the side view of detail A′ of FIG. 3.

FIG. 6 shows the isometric view of detail A′ of FIG. 3.

FIG. 7 shows the exploded isometric view of a side window with LOCA, thermoplastic interlayer, and active insert.

FIG. 8 shows the exploded isometric view of a VLT active insert.

FIG. 9A shows the cross-section of a laminate with LOCA and interlayer where a thin flat connector passes through interlayer according to an embodiment of the invention.

FIG. 9B shows the cross-section of a laminate with LOCA and interlayer with wire embedded in interlayer according to an embodiment of the invention.

FIG. 10 shows the cross-section of a laminate with reinforcement bonded to edge of glass with a thermoset adhesive according to an embodiment of the invention.

FIG. 11A shows the cross-section of a laminate with molded reinforcement with harness connector wire positioned parallel to the edge of glass and bonded to an internal conductor according to an embodiment of the invention.

FIG. 11B shows the cross-section of a laminate with molded reinforcement with harness connector wire positioned perpendicular to the edge of glass and bonded to an internal conductor according to an embodiment of the invention.

### REFERENCE NUMERALS OF THE DRAWINGS

2 Glass/Pane
4 Solid polymer interlayer/transparent thermoplastic interlayer
6 Obscuration/Black Paint
12 Infrared reflecting performance film
20 Edge Seal
22 Liquid Optically Clear Adhesive (LOCA)
24 Active insert
26 Conductive coating
28 Insert electrical connection
30 Wiring harness connector
32 Electrical connection point one
40 VLT Bus bar
42 VLT conductive coating
44 VLT emulsion
46 Thin flat electrical insulating material
48 Conductor
50 VLT substrate
52 Round wire
54 Thin flat electrical conductor
56 Electrical connection point two
60 Reinforcement
62 Thermoset adhesive
64 High tack adhesive
66 Over mold/shell
101 Exterior side of glass layer one (201), surface number one.
102 Interior side of glass layer one (201), surface number two.
103 Exterior side of glass layer two (202), surface number three.
104 Interior side of glass layer two (202), surface number four.
201 Outer glass-layer one
202 Inner glass-layer two

### DETAILED DESCRIPTION OF THE INVENTION

The present disclosure can be understood more readily by reference to the detailed descriptions, drawings, examples, and claims in this disclosure. However, it is to be understood that this disclosure is not limited to the specific compositions, articles, devices, and methods disclosed unless otherwise specified and as such can vary. It is also to be understood that the terminology used herein is for the purpose of describing aspects only and is not intended to be limiting.

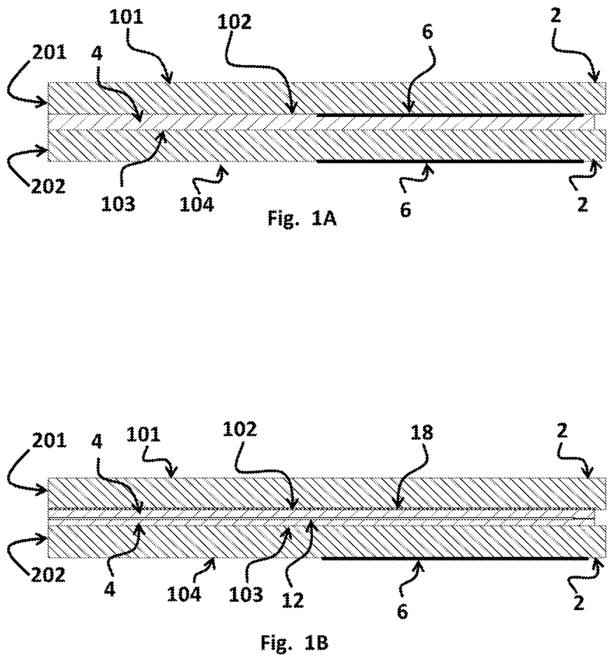

Typical automotive laminated glazing cross-sections are illustrated in FIGS. 1A and 1B. The laminate is comprised of two layers of glass 2, the exterior or outer glass layer, 201 and interior or inner glass layer, 202 that are permanently bonded together by a polymer layer 4 (interlayer). In a laminate, the glass surface that is on the exterior of the vehicle is referred to as surface one, 101, or the number one surface. The opposite face of the exterior glass layer 201 is surface two, 102, or the number two surface. The glass 2 surface that is on the interior of the vehicle is referred to as surface four, 104, or the number four surface. The opposite face of the interior layer of glass 202 is surface three, 103, or the number three surface. Surfaces two, 102, and three, 103 are bonded together by the polymer layer 4. An obscuration 6 may be also applied to the glass. Obscurations are commonly comprised of black enamel frit printed on either the number two, 102 or number four surface 104 or on both. Obscurations can also be provided with painted or opaque plastic layers such as interlayers, as well as by the use of organic paint. The laminate may have a coating 18 on one or more of the surfaces. The laminate may also comprise a film 12 laminated between at least two polymer layers 4.

The following terminology is used to describe the laminated glazing of the invention.

The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

The glazing is made of either a single pane or a composite pane. In the case of a single pane, it generally refers to a glass layer. On the other hand, a composite pane usually comprises two transparent substrates (e.g. glass and/or polymeric substrates) that are bonded to one another by at least one thermoplastic adhesive layer (bonding layer/interlayer).

While the focus of the embodiments and discussion is on door windows it can be appreciated that the invention is not limited to door windows. The invention may be implemented in any of the other glazing positions of the vehicle. In addition, the invention may be practiced with any type of glazing and is not limited to automotive.

A variety of thermoset LOCAs are available. As the items being laminated, are transparent, the most convenient LOCA type for automotive glazing are those that are cured by means of exposure to light. LOCAs are available that are sensitive to and cured at various light frequencies with UV being the most common. However, this is not to be taken as a limitation. LOCAs that are cured by other means may be used and are considered as equivalent. LOCAs can be added by different means such as injection, dispensing, spraying, jet-spraying, spin coating or die casting; such addition may be performed under vacuum conditions.

The active insert refers to films on which the level of light transmission can be varied electrically which include switchable films selected from suspended particle device (SPD), polymer dispensed liquid crystal (PDLC), Polymer Network Liquid Crystal (PNLC), liquid crystal (LC), electrochromic, electrophoretic, electrowetting, photochromic, thermochromic; optoelectronic devices such as photovoltaic cells, photodiodes, LED, and light sensors; capacitive devices selected from touch sensors, heating, and antennas; flexible light guiding devices; displays; HUD or holographic films; piezoelectric components for haptic feedback; among others.

The edges of the active insert and electrical connections are normally hidden from view from the interior or exterior of the vehicle by an obscuration. An opaque, obscuration is typically applied to surface two 102 of the outer glass layer 201. A second obscuration is printed on surface four 104 of the inner glass layer 202. Additionally, if applicable, at least one obscuration is provided with a painted or opaque plastic interlayer.

The width of the obscuration is sufficient to hide both the edge sealer and the portions of the active insert that are not intended to be visible. This includes any electrical connection points.

The purpose of the invention is to provide a reliable electrical connection between the harness connector in the exterior of the glazing to the active film disposed in the interior of the glazing. For that a protection means may be selected from an electrical bridging means, a reinforcement element or a combination thereof. Multiple bridging means have been developed which will now be described.

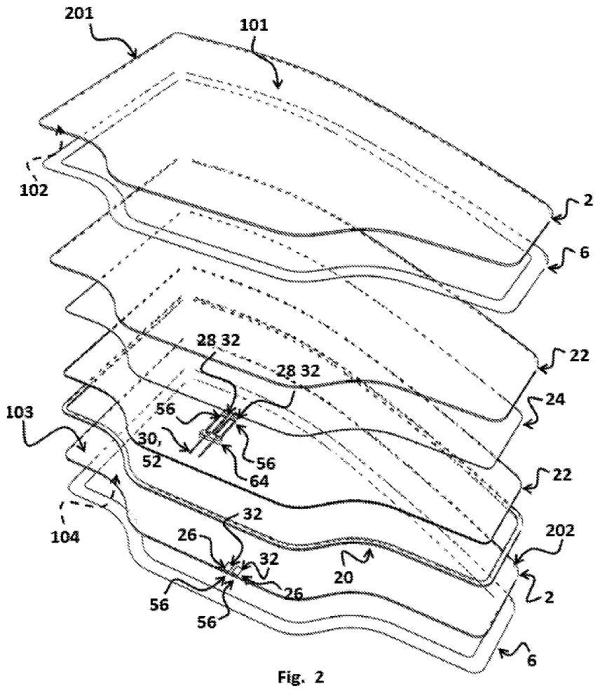

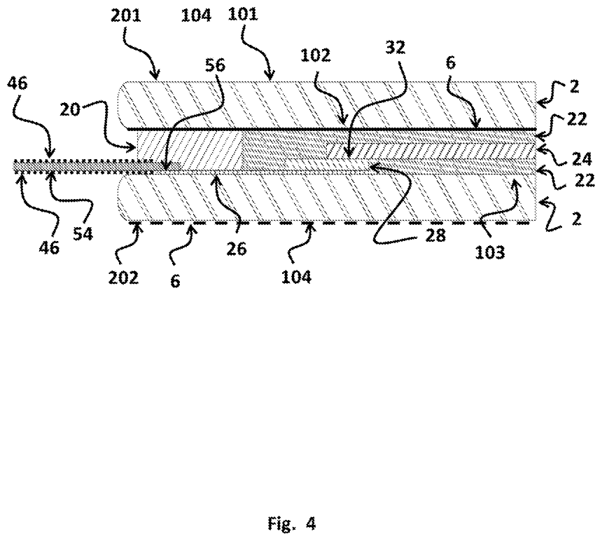

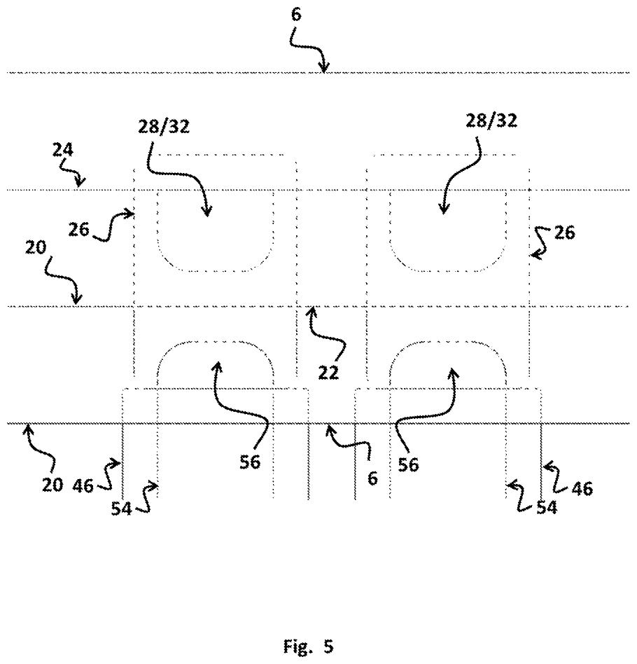

In a first bridging means, a conductive coating 26 is applied to the glass surface and may be used to bridge the edge seal 20 as shown in FIGS. 2, 3, 4, 5,6 and 7. The electrical connection 28 of the active insert 24 is inboard of the edge seal 20. A conductive coating 26, with a sheet resistance low enough to power the active insert, is applied to at least one of the glass surfaces, surface three, 103 in these illustrations. It has been found that the silver frit used to print heating circuits on glazing works well. With a sheet resistance in the low milli-ohm per square range silver frit offers excellent solderability and is just one option. Other methods of applying a metallic conductive coating may be used. Silver frit also works well with higher current active inserts such as heated circuits and lighting. For low power active inserts 24, such as VLT films, an MSVD silver-based coating or an ITO coating may be used. The MSVD coating may be applied to the entire surface with the circuit required to connect the active insert formed by a deletion means. The most commonly used deletion means is done using a LASER system though it may also be accomplished by an abrasive wheel, masking, etching or other means.

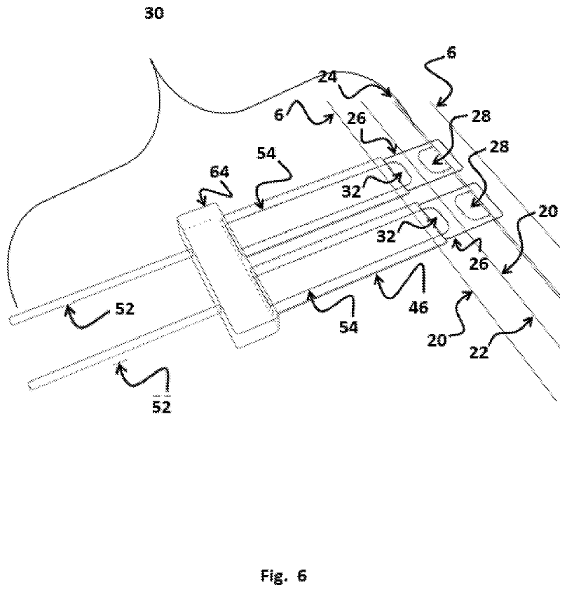

In FIGS. 2-7, the active insert 24 has an electrical connection which is soldered to the silver frit conductive coating 26 at point one 32. The conductive coating extends through and under the edge seal 20 which serves as a dam to contain the LOCA 22 during the cold lamination fill process. A thin flat copper strip 54 (electrical conductor) encapsulated between two layers of polyimide tape 46 (electrical insulating material) with acrylic adhesive is soldered to the end of the conductive coating at point two 56. The silver frit conductive coating 26 becomes vitrified and fused to the glass surface 103 during the glass bending process and as a result has excellent adhesion to the glass surface 103. The silver frit also has a very rough and porous surface giving it high adhesion to both the LOCA 22 and edge seal 20. The thin flat copper strip 54 only partially encroaches upon the edge seal 20 if at all limiting the depth of penetration in the event of a failure of the bond between the edge seal and the polyimide tape 46 and conductor 54. If space permits, the width, the location of the edge seal 20 or both may be modified to facilitate soldering of the connector conductor 54. While the connection is show as being very close to the edge of glass in the figures, note that the drawings are illustrative and not drawn to scale. In practice the flat conductor 54 would extend at least 12 mm inboard of the edge of glass and preferably even further.

Other means are known in the art to deposit a conductive material on glass including but not limited to MSVD, solgel, flame spray and pyrolytic coating. The coating may also comprise a thin conductive layer bonded to the glass surface by a high tack adhesive 64. The conductive coating may also comprise carbon nano-tubes, silver nano-wires, metallic nano-particles or other similar conductive materials deposited directly onto the glass surface or onto the interlayer.

The conductive region produced by any of these means shall be considered as the conductive coating 26. Any and all may be employed without deviating from the intent of this disclosure.

On some laminates a hybrid lamination approach may need to be used, combining both an autoclave processed solid interlayer and cold lamination LOCA. This can be done when a sheet of solid interlayer is needed to protect the active insert materials from UV and near UV exposure and long-term degradation. While automotive interlayers typically block at least 99% of ultraviolet (UV) light, specially formulated interlayers are available that provided a higher level of UV protection than normal interlayers and also block near UV light spectra.

Prior to laminating however, interlayers have an embossed surface, are not transparent and require heat and pressure to bond to the glass as well as to become transparent and optically clear. Therefore, the interlayers must first be processed in an autoclave to eliminate the embossing and optically convert to a transparent state. To do so, the glass layers and the interlayer are assembled as they would for a normal laminate. The only difference is that a sacrificial sheet of material that the interlayer does not readily adhere to, is placed between the interlayer and the glass layer that we do not want the interlayer to bond to. The assembly then goes through the autoclave lamination process which causes the interlayer to adhere to the glass layer not separated by a sacrificial layer. Afterwards, the layers are separated, and the sacrificial sheet is discarded. However, when needed the sacrificial layer can be maintained such that the sacrificial layer is an additional layer included in the laminate to serve as an isolator layer. The edge seal, active insert and other components can then be assembled, and the cold lamination process completed. The sacrificial layer can be selected from the group consisting of a glass layer, a polyethylene terephthalate (PET), a polycarbonate (PC), and a polymethyl methacrylate (PMMA).

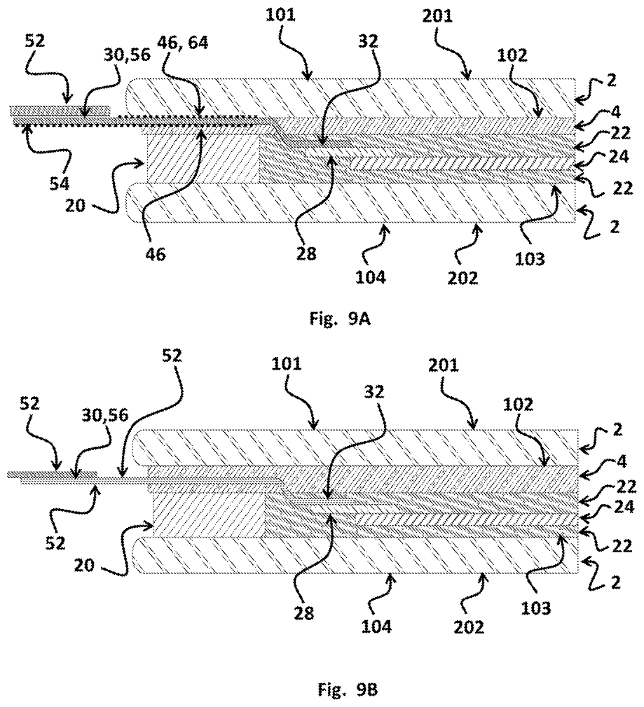

On laminates having an interlayer, the bridging element can be implemented by embedding wire 52 in the interlayer 4. In FIG. 9B this method is illustrated. The wire 52 connects the harness connector 30 at point two 56 and at the other end of the wire to the active insert connection 28 at point one 32. The wire 52 embedded in the interlayer 4 is processed in the autoclave and adhered to the glass surface.

In FIG. 9A this same method is illustrated with a thin flat conductor 54 rather than an embedded wire. The thin flat conductor 54 connects the harness connector 30 at point two 56 and at the other end of the wire to the active insert connection 28 at point one 32. During the initial assembly, prior to the autoclave cycle, the thin flat conductor 54 is passed through a slit cut in the interlayer 4. The thin flat conductor 54 is insulated by a layer of polyimide tape 46. The tape may be bonded to surface two 102 of the outer glass layer 201. A high tack adhesive 64 may also be used to bond the opposite side of the conductor 54 to the interlayer 4.

As discussed, the thin copper strip 54 used is weak and at elevated risk of failure. The strip can only be bent and flexed a small number of times before it will fatigue and crack. It also can be easily torn. Even if not damaged, if pulled upon the bond between the strip and the polymers used to hold it in place can weaken. The same can occur due to the long-term effects of normal vibration as well as contraction and expansion due to temperature changes.

Optionally in conjunction with the bridging methods disclosed or in place of, a reinforcement 60 may be used to protect a portion of the connector. This also provides an opportunity to apply a secondary seal to the edge of glass. The transition from the flat conductor to a stranded wire may also be provided within the reinforcement. In this case, the reinforcement 60 replaces the high tack adhesive or mold 64.

The reinforcement element may be used collaboratively with the bridging means described: conductive coating, embedded wire and conductor passing through at least one interlayer, or with other connecting methods. The reinforcement may comprise a single or multiple components that are assembled and bonded to the glass and electrical connector components. The reinforcement may be comprised of a molded thermoset or thermoform plastic. The reinforcement prevents any movement of the conductors entering the laminate and, in this manner, prevents the possibility of the seal being compromised.

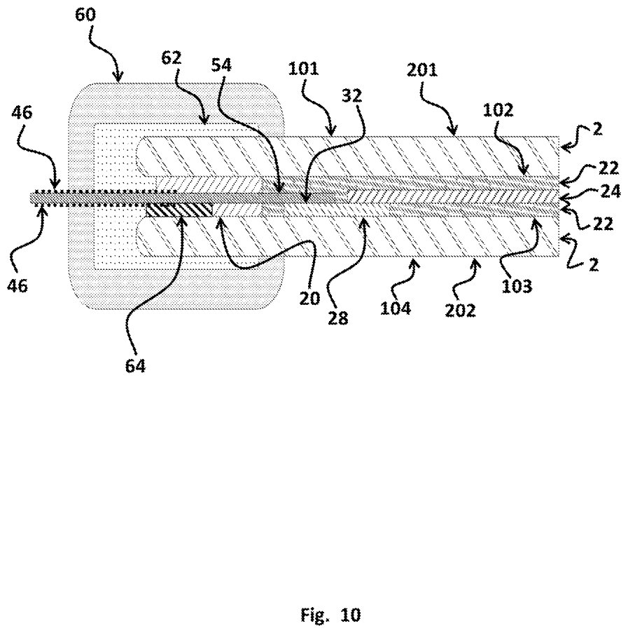

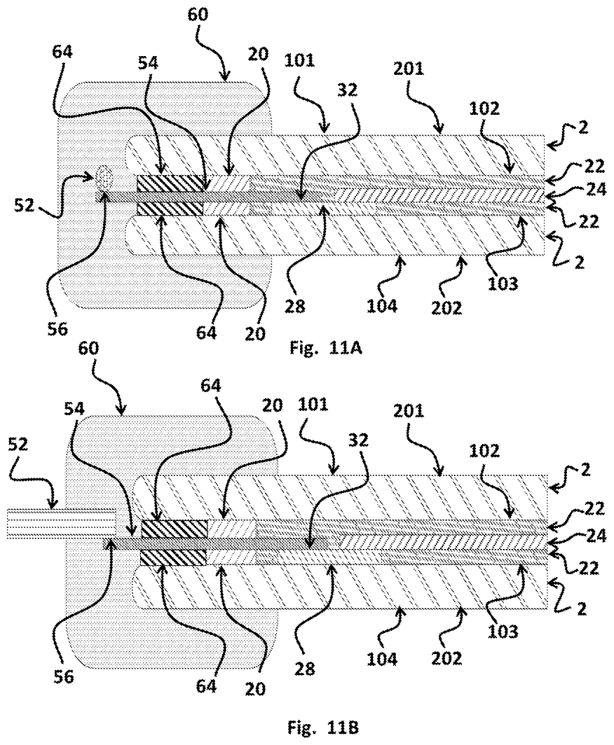

In FIG. 10, a reinforcement 60 is shown that comprises two opposite shells with a cavity in each sized to fit the edge of glass and the thin flat insulated 46 conductor 54 extending from the edge of the laminate. The cavity of each half is filled with a thermoset adhesive 62, assembled to the laminate and then clamped in place until the adhesive 62 has cured. In FIGS. 11A and 11B, the reinforcement 60 comprises a polymer over-mold applied over the glass and the thin flat conductor 54 of the connector as well as the round wire 52 soldered to the thin flat conductor 54 at point two 56. The reinforcement 60 is made by clamping a mold over the edge of glass and then extruding a thermoset or thermoform plastic into the mold cavity. In FIGS. 11A and 11B, the thin flat conductor 54 is connected to the active insert 24 at point one 32 and to the vehicle harness connector wire 52 at point two 56. In FIG. 11A, the wire 52 is soldered to the flat conductor 54 such that the wire 52 is parallel to the edge of glass. In FIG. 11B, the wire 52 is soldered to the flat conductor 54 such that the wire 32 is perpendicular to the edge of glass.

When glass and plastics are tightly bonded and unable to flex, the mismatch between the coefficients of thermal expansion can cause problems. This is especially true for the stiffer plastics. Most of the commonly used automotive polymers have a coefficient of expansion that is 3-4 times that of soda lime glass. Glass breakage has been known to occur due to a poorly matched plastic being bonded to glass. The more likely problem is that the seal between the plastic and the bond may be broken over time.

In FIG. 10, the reinforcement 60 is comprised of an injection molded shell that is bonded to the glass by means of an adhesive 62 that will remain flexible after curing. FIGS. 11A and 11B show a different approach. Here, the reinforcement 60 is injection molded over the glass. However, the coefficient of thermal expansion mismatch between the polymer and the glass is minimized by adding a low expansion coefficient additive, such as 20 μm borosilicate glass beads to the plastic (not showed). In this way, the glass and reinforcement do not experience a high degree of relative movement relative to each other and remain stable.

The reinforcement 60 can also be applied such as it encircles the harness connectors round 52 or flat conductor 54 in the edge of the glazing, however not limited to being completely adhered to surface one and surface four of the glazing. If could be located only in the edge of the glazing.

The reinforcement element can work collaboratively with the bridging means to provide additional protection of the harness connectors.

Some laminates include at least one composite pane comprising a glass layer, a sacrificial layer and a solid polymer interlayer disposed between the glass layer and the sacrificial layer; wherein the bridging means comprises at least one wire which passes through an opening in the sacrificial layer and is embedded within the solid polymer interlayer such that the at least one wire extends from the active insert connection point to the wiring connector connection point; and wherein the wiring connector is electrically bonded to an outboard portion of the wire, and said active insert connection point is electrically bonded to an inboard portion of the wire. While on some laminates the at least one pane is a composite pane comprising a glass layer, a sacrificial layer and a solid polymer interlayer disposed between the glass layer and the sacrificial layer; wherein the bridging means comprises at least one thin flat conductor bonded to the solid polymer interlayer; wherein said at least one thin flat conductor passes through an opening in the sacrificial layer and the solid interlayer from the insert connection point side to the glass side of the solid interlayer such that the at least one thin flat conductor extends from the active insert connection point to the wiring connector connection point; and wherein said wiring connector is electrically bonded to an outboard portion of the thin flat conductor, and said active insert connection point is electrically bonded to an inboard portion of the thin flat conductor. In some of these laminates, the sacrificial layer is a PET layer.

### Embodiments

1. Embodiment one of the invention is a laminated glazing comprised of two glass layers, outer and inner, wherein an active film is disposed in between the glass layers. A curable liquid optically clear adhesive is used to bond the active film to the glass layers. The active film has a connection point that is connected to the connection point of the hardness connector in the exterior of the glazing. The glazing edges are sealed with an edge sealing. A protection means is used to provide a reliable connection between the active film and the harness connector, protecting against external fluids, humidity, and external agents, and also providing mechanical resistance to the connection.

2. Embodiment two is the laminated glazing of embodiment one wherein the protection means is a bridging means selected from the group of conductive coating, embedded wire and conductor passing through the interlayer.

3. Embodiment three is the laminated glazing of embodiment one wherein the protection means is a reinforcement element.

4. Embodiment four is the laminated glazing of embodiment one wherein the protection means is a combination of a reinforcement element and a bridging means selected from the group of conductive coating, embedded wire and conductor passing through the interlayer.

5. Embodiment five is the laminated glazing of any of the embodiments one to four wherein the active insert is a LC VLT film.

6. Embodiment six is similar to embodiment five with the exception of the active insert. The active insert is a PDLC VLT film.

7. Embodiment seven is similar to embodiment five with the exception the active insert. The active insert is a SPD VLT film.

8. Embodiment eight is similar to embodiment five with the exception the active insert. The active insert is an electrochromic VLT film.

9. Embodiment nine is similar to embodiment five with the exception the active insert. The active insert is a LED lighting circuit.

10. Embodiment ten is similar to embodiment five with the exception the active insert. The active insert is a heating circuit.

11. Embodiment eleven is similar to embodiment five with the exception the active insert. The active insert is a touch sensitive film.

12. Embodiment twelve is similar to embodiment five with the exception the active insert. The active insert is set of driver assistant sensors.

13. Embodiment thirteen is similar to embodiment five with the exception the active insert. The active insert an electroluminescent display.

### EXAMPLES

Example one is the LOCA laminated front door window aspects of which are shown in FIGS. 2, 3, 4, 5, 6 and 8. The inner 202 and outer 201 glass layers are 2.1 mm clear soda-lime glass.

A black frit obscuration 6 is screen printed on surface two 102. Surface four 104 of the inner glass layer 202 is printed with a pattern that has voids in the print totaling 10% of the printed area to allow for the UV LOCA to cure.

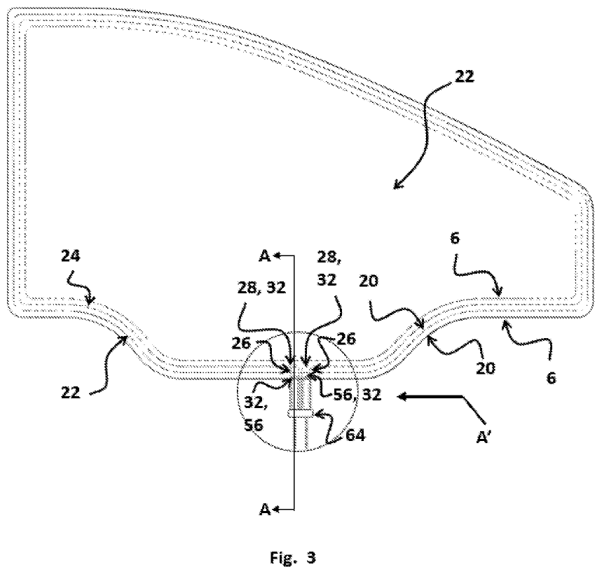

Surface three 103 is masked off and a conductive coating is applied to the two areas show in Detail A of FIG. 3. The conductive coated areas have an approximate dimension of 15 mm×30 mm.

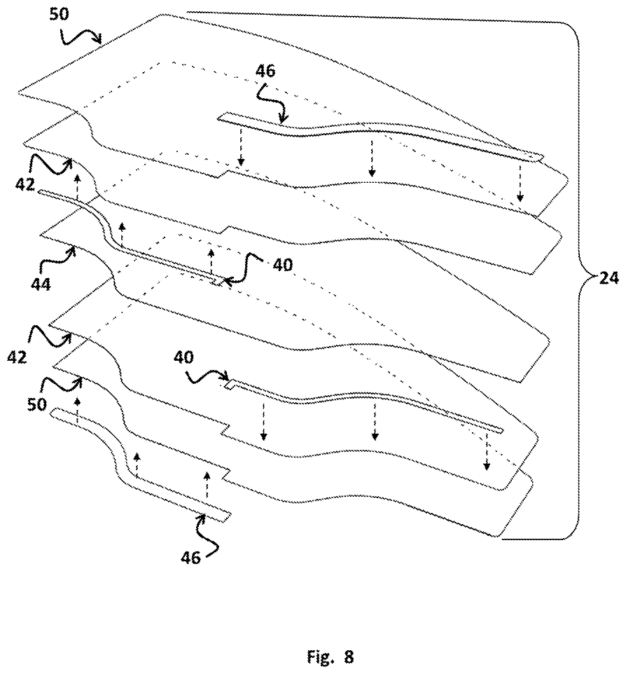

The active insert 24 is a sheet of SPD VLT as shown in FIG. 8. The SPD film 24 is made by extruding an emulsion 44 containing the active material (SPD) between two sheet of 120 μm thick Indium Tin Oxide (ITO) coated 42 PET transparent film 50. Along the left bottom edge of the first PET substrate 50 the PET is cutback and the emulsion 44 is removed exposing the ITO 42. A 70 μm×6 m wide copper bus bar 40 is applied directly to the exposed ITO coating and a layer of black polyamide tape 46, with a thickness of 50 μm, is wrapped around the edge sealing it. The process is repeated along the bottom right side of the second PET substrate 50. The ends of the bus bars near the center of the part, as shown in detail A, are bent over at a 90-degree angle to provide the electrical connection point. Transparent spacers are applied to the film to support and center the film within the laminate and the film is placed on surface three, 103 of the inner glass layer 202.

The two electrical connections 28 from the active insert 24 are bonded to the conductive coating 26 by means of a conductive adhesive. The harness connector 30 electrical connection points 56 are bonded in the same manner to the outboard portion of the conductive coating 26.

A 3 mm×10 mm edge seal 20 is extruded around the periphery. The outer glass layer 201 is matched with the edge seal 20 and after curing of the edge seal, the assembly is filled with LOCA 22 and cured.

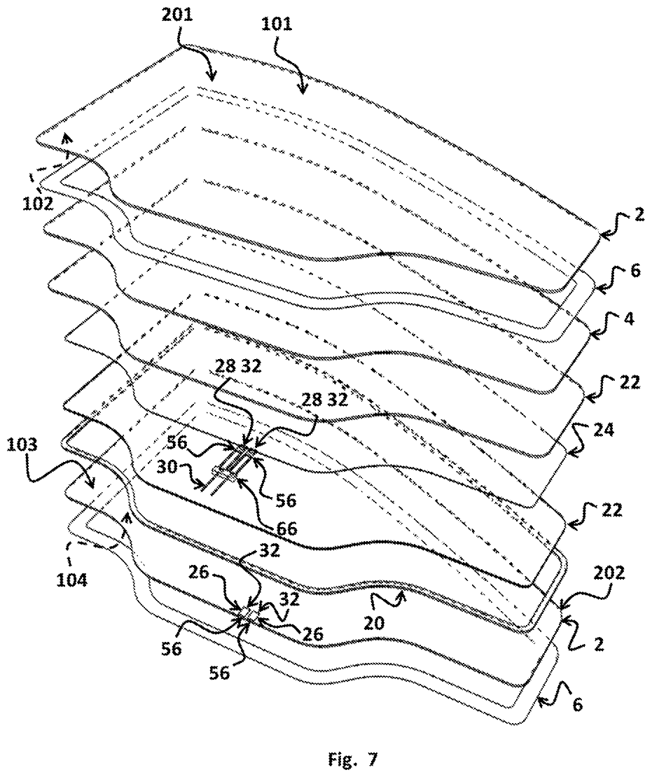

Example two is similar to example one and can be seen in the exploded isometric view of FIG. 7. The only difference is the addition of an 0.76 PVB 4 layer added to improve penetration resistance and UV protection. The inner glass layer 202 is printed with a black obscuration 6 and fired as in example one and has a conductive coating 26 applied. The outer layer 201 is then assembled with first the PVB layer 4 with a polyester sheet between the interlayer and the inner glass layer to prevent bonding, the inner glass layer 202 and processed in an autoclave. After lamination, the layers are separated, and the polyester sheet is discarded. The connector, edge seal and active insert are assembled, and the assembly is then filled with a LOCA. The process is then completed as in example one.

Example three is similar to example two with the exception of the bridging means. Instead of a conductive coating, a set of two 100 μm copper wires are embedded in the PVB layer prior to autoclave processing. After cold lamination, a mold is clamped to the edge of glass and a polymer with an index of thermal expansion modified to be less than twice that of the glass is injected over the electrical connector.

Example four is similar to example three with the exception the bridging means. Rather than embedded copper wires, a set of 6 mm wide, 70 μm thick, flat copper strips are passed through a slit in the PVB and then adhered to the PVB and glass by means of a paper release backed high tack adhesive 64 prior to autoclave processing. After cold lamination, a shell filled with an adhesive that is coefficient of thermal expansion matched to less than twice that of the glass is clamped to the edge of glass and cured.

1. A laminated glazing comprising:
two panes, an outer pane and an inner pane, each pane having an exterior surface oriented towards the outside of the laminated glazing, an interior surface oriented towards the inside of the laminated glazing, and an edge surface;
an edge sealing means disposed in between said outer and inner panes and applied around the periphery of the glazing;
a curable liquid optically clear adhesive added into the laminate in at least a portion of the void between the two panes and serving to permanently join at least a portion of the interior surfaces of said two panes;
an active insert having at least one electrical connection point;
a wiring connector having at least one electrical connection point; and
a protection means serving to protect the wiring connector.

2. The laminated glazing of claim 1, wherein each pane is selected from the group consisting of a single pane and a composite pane.

3. The laminated glazing of claim 2, wherein the single pane is a glass layer.

4. The laminated glazing of claim 2, wherein the composite pane comprises a glass layer, a solid polymer interlayer and a sacrificial layer.

5. The laminated glazing of claim 4, wherein the sacrificial layer is selected from the group consisting of a glass layer, a polyethylene terephthalate (PET), a polycarbonate (PC), and a polymethyl methacrylate (PMMA).

6. The laminated glazing of claim 1, wherein the protection means is a bridging means that provides electrical connection from the wiring connector connection point to the active insert electrical connection point, and wherein said bridging means does not pass through the edge sealing means.

7. The laminated glazing of claim 6, wherein the bridging means comprises a conductive coating applied to at least a portion of at least one pane interior surface such that the coated area extends from the active insert connection point to the wiring connector connection point; wherein the wiring connector is electrically bonded to an outboard portion of the conductive coated area; and wherein the active insert connection point is electrically bonded to an inboard portion of the conductive coated area.

8. The laminated glazing of claim 6, further comprising a solid polymer interlayer bonded to one of the pane interior surfaces; and wherein the bridging means comprises at least one wire embedded within the solid polymer interlayer such that the at least one wire extends from the active insert connection point to the wiring connector connection point; and wherein the wiring connector is electrically bonded to an outboard portion of the wire, and said active insert connection point is electrically bonded to an inboard portion of the wire.

9. The laminated glazing of claim 6, further comprising a solid polymer interlayer bonded to one of the pane interior surfaces; and wherein the bridging means comprises at least one thin flat conductor bonded to the solid polymer interlayer; wherein said at least one thin flat conductor passes through an opening in the solid interlayer from the insert connection point side to the pane side of the solid interlayer such that the at least one thin flat conductor extends from the active insert connection point to the wiring connector connection point; and wherein said wiring connector is electrically bonded to an outboard portion of the thin flat conductor, and said active insert connection point is electrically bonded to an inboard portion of the thin flat conductor.

10. The laminated glazing of claim 6, wherein at least one pane is a composite pane comprising a glass layer, a sacrificial layer and a solid polymer interlayer disposed between the glass layer and the sacrificial layer; wherein the bridging means comprises at least one wire which passes through an opening in the sacrificial layer and is embedded within the solid polymer interlayer such that the at least one wire extends from the active insert connection point to the wiring connector connection point; and wherein the wiring connector is electrically bonded to an outboard portion of the wire, and said active insert connection point is electrically bonded to an inboard portion of the wire.

11. The laminated glazing of claim 6, wherein at least one pane is a composite pane comprising a glass layer, a sacrificial layer and a solid polymer interlayer disposed between the glass layer and the sacrificial layer; wherein the bridging means comprises at least one thin flat conductor bonded to the solid polymer interlayer; wherein said at least one thin flat conductor passes through an opening in the sacrificial layer and the solid interlayer from the insert connection point side to the glass side of the solid interlayer such that the at least one thin flat conductor extends from the active insert connection point to the wiring connector connection point; and wherein said wiring connector is electrically bonded to an outboard portion of the thin flat conductor, and said active insert connection point is electrically bonded to an inboard portion of the thin flat conductor.

12. The laminated glazing of claim 1, wherein the protection means is a reinforcement element bonded to at least one edge surface of said two panes enclosing said at least one edge surface and the conductor in electrical contact with the active insert, preventing movement of the conductor, and providing a watertight seal.

13. The laminated glazing of claim 12, wherein the reinforcement element comprises one or more components bonded to the pane.

14. The laminated glazing of claims 12, wherein the reinforcement element is molded to at least one edge surface of said two panes.

15. The laminated glazing of claim 12, wherein the reinforcement element is bonded to the pane by means of an adhesive with a coefficient of thermal expansion that is no more than twice that of the pane.

16. The laminated glazing of claim 12, wherein the reinforcement element comprises a polymer with a coefficient of thermal expansion that is no more than twice that of the pane.

17. The laminated glazing of claim 1, wherein the protection means is a combination of a bridging means and a reinforcement element configured to work collaboratively.

18. The laminated glazing of claim 1, wherein the active insert comprises: a switchable film selected from suspended particle device (SPD), polymer dispensed liquid crystal (PDLC), PNLC, liquid crystal (LC), electrochromic, electrophoretic, electrowetting, photochromic, and thermochromic; an optoelectronic devices such as photovoltaic cells, photodiodes, LED, and light sensors; a capacitive devices selected from touch sensors, heating, and antennas; flexible light guiding devices; displays; HUD or holographic films; and piezoelectric components for haptic feedback.

19. The laminated glazing of claim 1, wherein the liquid optically clear adhesive is added by means of injection, dispensing, spraying, jet-spraying, spin coating or die casting.

20. The laminated glazing claim 1, wherein each pane is a single layer made of glass.

21. (canceled)
